(19) United States
(12) Patent Application Publication
(10) Pub. No.: US 2026/0329764 A1
(43) Pub. Date: Oct. 22, 2026

(54) DATA REORDERING DURING GARBAGE COLLECTION TO MITIGATE WRITE AMPLIFICATION IN A MEMORY SUB-SYSTEM

(71) Applicant: Micron Technology, Inc., Boise, ID (US)

(72) Inventors: Kishore Kumar Muchherla, San Jose, CA (US); Jonathan S. Parry, Boise, ID (US); Xiangyu Tang, San Jose, CA (US); Che Chen, Boise, ID (US); Michael G. Miller, Boise, ID (US); Peter Feeley, Boise, ID (US); Akira Goda, Tokyo (JP)

(21) Appl. No.: 19/185,817

(22) Filed: Apr. 22, 2025

(51) Int. Cl. G06F 12/02

(52) U.S. Cl. CPC G06F 12/0253; G06F 12/0246

(57) ABSTRACT

A processing device in a memory system determines that a criterion to perform a garbage collection operation for a set of source data blocks of the memory device is satisfied. The processing device identifies a set of destination data blocks. The processing device identifies valid data in the set of source data blocks, where a first portion of the valid data includes a first type of data and a second portion of the valid data includes a second type of data. The processing device transmits the first portion of the valid data to a first destination data block of the set of destination data blocks and transmits the second portion of the valid data to a second destination data block of the set of destination data blocks. The processing device releases at least one of the set of source data blocks.

### TECHNICAL FIELD

Embodiments of the disclosure relate generally to memory sub-systems, and more specifically, relate to data reordering during garbage collection to mitigate write amplification in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram illustrating a garbage collection process, in accordance with embodiments of the present disclosure.

FIG. 3 is a block diagram illustrating a reordering process during garbage collection, in accordance with embodiments of the present disclosure.

FIG. 4 is a flow diagram of an example method to reorder data during garbage collection to mitigate write amplification, in accordance with some embodiments of the present disclosure.

FIG. 5 is a block diagram of an example computer system in which embodiments of the present disclosure may operate.

### DETAILED DESCRIPTION

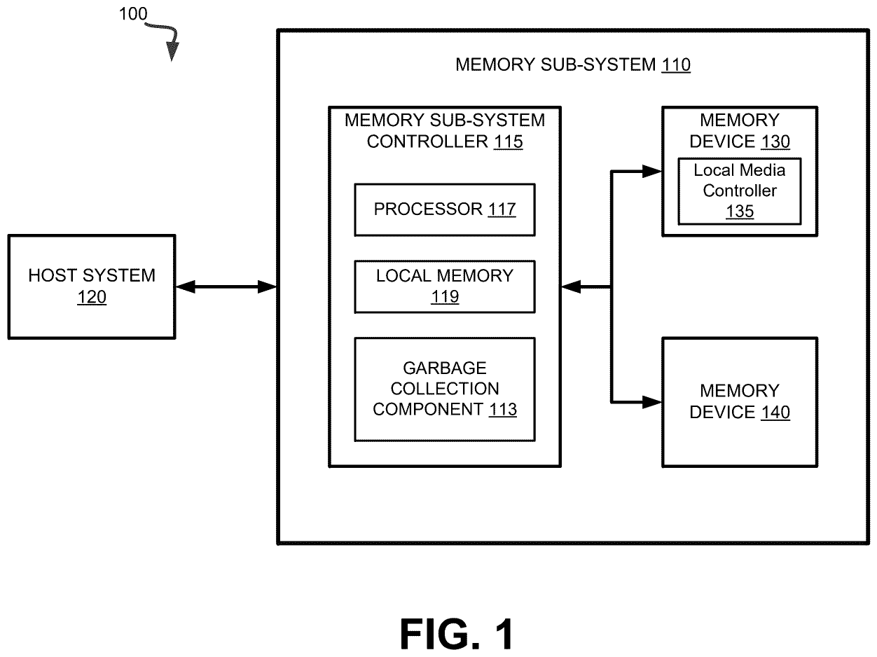

Aspects of the present disclosure are directed to data reordering during garbage collection to mitigate write amplification in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

When a host system requests to store data, the data is stored at a physical address within a memory component in a memory sub-system. The host system provides a logical address identifying the data to be stored. A logical to physical (L2P) mapping table is maintained to identify the physical location where the data corresponding to each logical address resides. When the data is written to the memory component, it is typically done at the page level, such that an entire page, or multiple pages, is written in a single operation. When the host system requests to update data at a particular logical address, the updated data is stored at a new physical location (e.g., a new physical address) and the L2P mapping is updated so that the particular logical address of the data is mapped to the new physical address. The original data (e.g., the data prior to the update) remains stored in the original physical address, but is no longer valid from the host's perspective, and is no longer usable by the host. With various changes in data, the memory component accumulates physical addresses across various data blocks that have invalid data, in addition to the physical addresses with valid data.

When the memory component is full, such that there is insufficient capacity to accept data from additional write operations, certain data (e.g., the invalid data) can be erased in order to free up space. When data is erased from the memory component, however, it is typically done at the block level, such that an entire block (including multiple pages) is erased in a single operation. However, as mentioned above, blocks can include both valid and invalid data. Thus, the entire block cannot be deleted without first preserving the valid data in the block.

Conventional systems perform a garbage collection operation to transfer valid data before erasing the block. A garbage collection (“GC”) operation involves migrating (e.g., rewriting) pages of the block that contain valid data (e.g., a source data block) to another block (e.g., a destination data block), so that the source data block can be erased. Garbage collection is a form of automatic memory management that attempts to reclaim garbage, or memory occupied by stale data objects that are no longer in use (e.g., because they have been updated with new values). The basic principle of garbage collection is to find data objects that cannot or need not be accessed in the future, and to reclaim the resources (i.e. storage space) used by those objects.

However, conventional garbage collection operations rewrite valid data to the destination source block without considering characteristics of the data (e.g., the length of time data is valid). Valid data can include long-term data, which is valid indefinitely (absent a command to erase) or for a long period of time (e.g., 6 months), and short-term data, which is valid for a short period of time (e.g., 2 hours). When stored together, the short-term data will become invalid faster and may cause the data block to be subject to another garbage collection operation while the long-term data is valid. As such, the valid long-term data will be rewritten to another data block, thereby increasing write amplification. Write amplification refers to when the amount of data written to a storage medium is significantly higher than the amount of data intended to be written to the system. Write amplification occurs during garbage collection because rewriting valid data to a new block constitutes an additional write that is not part of the original workload (e.g., writing the data once). The additional write operations can accelerate the degradation of memory cells (e.g., additional writes can wear down the cell and cause it to lose data retention faster) and consume additional processing power (e.g., to perform the additional write operations). As such, conventional garbage collection operations increase write amplification by storing both valid long-term data and short-term data in the same destination data block, accelerating the degradation of memory cells and increasing the consumption of processing power of the memory sub-system.

Aspects of the present disclosure address the above and other deficiencies by providing a memory sub-system that reorders data during garbage collection to reduce write amplification in the memory sub-system. In one embodiment, processing logic in a memory sub-system determines that a criterion to perform a garbage collection operation for a set of source data blocks is satisfied (e.g., a data capacity of the system reaches a threshold, a command to perform a garbage collection operation is received, etc.). The processing logic identifies valid data in the set of source data blocks and segregates the valid data, while migrating the valid data of one data type (e.g., long-term data that will be valid for a longer period of time) to one destination data block and valid data of another data type (e.g., short-term data that will soon become invalid) to a second destination data block. The processing logic then erases invalid data in the set of source data blocks and/or marks the set of source data blocks for erasure of invalid data (e.g., changing a characteristic of the data block to indicate that the data in the block can be erased).

Advantages of the present disclosure include, but are not limited to, reducing write amplification in a garbage collection operation. By sorting data into different destination blocks based on a data type, the amount of valid data that is rewritten can be reduced for future garbage collections. For example, valid long-term data can be transmitted (e.g., written) to one destination data block and valid short-term data can be transmitted to a separate destination data block.

Sorting data based on the amount of time the data will be valid decreases the amount of valid data remaining in the block at the time of a garbage collection operation, as the majority of the data will become invalid around the same time. For example, when a garbage collection operation is performed on a block that contains only short-term data, the majority of the data in the block will likely be invalid due to the similar lifespans of the data, as compared to a block that contains both short-term and long-term data. As such, the amount of valid data in the data block that is rewritten to a separate data block is reduced, reducing the write amplification of the garbage collection process. The reduction in write amplification can increase the lifespan of memory cells by reducing the number of write operations that wear out the cell and improve performance and efficiency of memory sub-systems by reducing the amount of processing power used to perform additional write operations in a garbage collection operation.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a garbage collection component 113 that can reorder data during garbage collection to reduce write amplification by sorting data into destination blocks based on a data type (e.g., a characteristic of the data, such as whether data is sequential). In some embodiments, the memory sub-system controller 115 includes at least a portion of the garbage collection component 113. In some embodiments, the garbage collection component 113 is part of the host system 120, an application, or an operating system. In other embodiments, local media controller 135 includes at least a portion of garbage collection component 113 and is configured to perform the functionality described herein.

The garbage collection component 113 can determine that a criterion to perform a garbage collection operation for a set of source data blocks is satisfied (e.g., a command to perform a garbage collection operation is received, a storage capacity of the memory sub-system has met a threshold value, etc.). The garbage collection component 113 can identify a set of destination data blocks for storing the valid data (e.g., data that is in use and/or accessible by the host system 120) in the set of source data blocks. The garbage collection component 113 then transmits (e.g., writes) valid data of one data type to one destination data block in the set of destination data blocks and valid data of a second data type to a separate destination block in the set of destination blocks. The garbage collection component 113 can then erase invalid data (e.g., data that is not in use and/or not accessible by the host system 120) remaining in the set of source data blocks and/or mark that the set of source data blocks can be erased (e.g., changing an attribute of the set of data blocks to indicate that data in the block can be erased). Further details with regards to the operations of the garbage collection component 113 are described below.

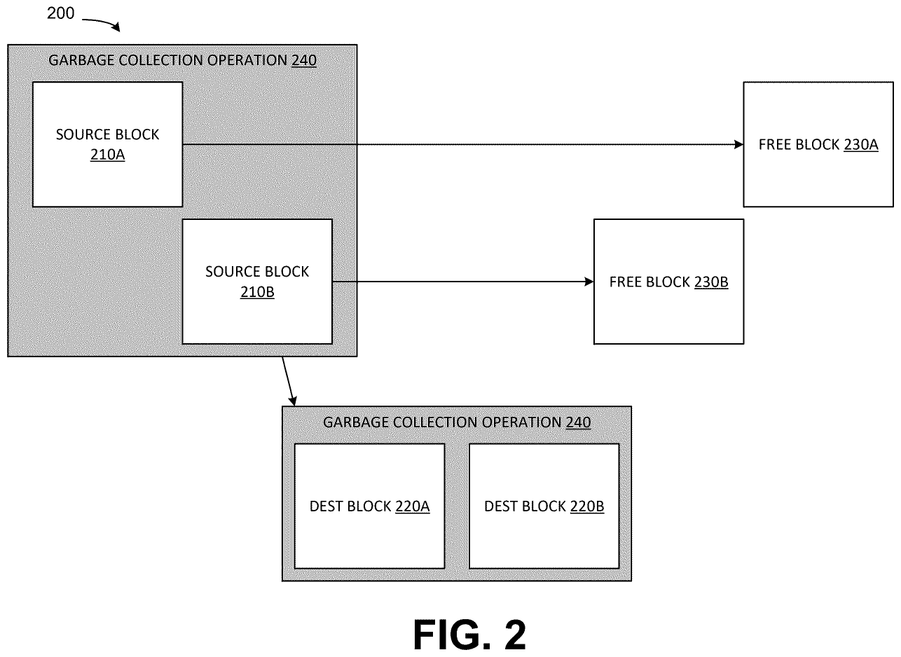

FIG. 2 is a block diagram illustrating a garbage collection process, in accordance with embodiments of the present disclosure. In one embodiment, blocks 240 indicate a garbage collection operation that is performed on source blocks 210A and 210B (herein referred to as source block(s) 210) and destination (dest) blocks 220A and 220B (herein referred to as destination block(s) 220). The free blocks 230A and 230B (herein referred to as free block(s) 230) refer to source blocks 210 after the invalid data is erased and new data can be written to the blocks.

In some embodiments, the garbage collection component 113 can determine that a criterion to perform a garbage collection operation 240 is satisfied. The garbage collection component 113 can identify source blocks 210 for the garbage collection operation 240 by determining which source blocks contain the most invalid data (e.g., by identifying the data blocks with the highest proportion of invalid data), in some embodiments. In other embodiments, the garbage collection component 113 can identify source blocks 210 by identifying data blocks with a low erase count (e.g., the amount of times the block has been erased) to prevent wear on blocks that have been erased multiple times. For example, in some embodiments, the garbage collection component 113 can maintain an erase counter for each block that indicates the amount of times the respective block has been erased. In other or similar embodiments, garbage collection component 113 can use a cost-benefit analysis that considers the amount of invalid data and the cost associated with moving data from a block (e.g., the amount of wear on the block based on the amount of times the block has been erased) to identify the source blocks 210.

Garbage collection component 113 can identify the destination blocks 220 by identifying free blocks that are available for new data to be written. In some embodiments, garbage collection component 113 can identify the destination blocks 220 by identifying free blocks with the lowest erase counts to prevent wear on the blocks. In other or similar embodiments, the garbage collection component 113 can also consider factors such as the type of data already stored in a block (e.g., blocks already containing long-term data can be chosen to store additional long-term data), the amount of wear on a block (e.g., a block with a high erase count may be chosen to store long term data to reduce the amount of times it is erased), and/or internal transfer overhead (e.g., delays due to plane alignment and/or cell type, such as single level cells, of the data blocks).

Garbage collection component 113 can identify valid data in source blocks 210 and write a first portion of the valid data including one data type to one destination block (e.g., destination block 220A) and a second portion of the valid data including another data type to a separate destination block (e.g., destination block 220B). In some embodiments, garbage collection component 113 can fill the first destination block (e.g., destination block 220A) to a threshold amount (e.g., to full capacity or a portion of the storage capacity) before writing the valid data of the second data type to the second destination block (e.g., destination block 220B). After the data is written, the source data blocks 210 can be released (e.g., erased of invalid data) and become free blocks 230.

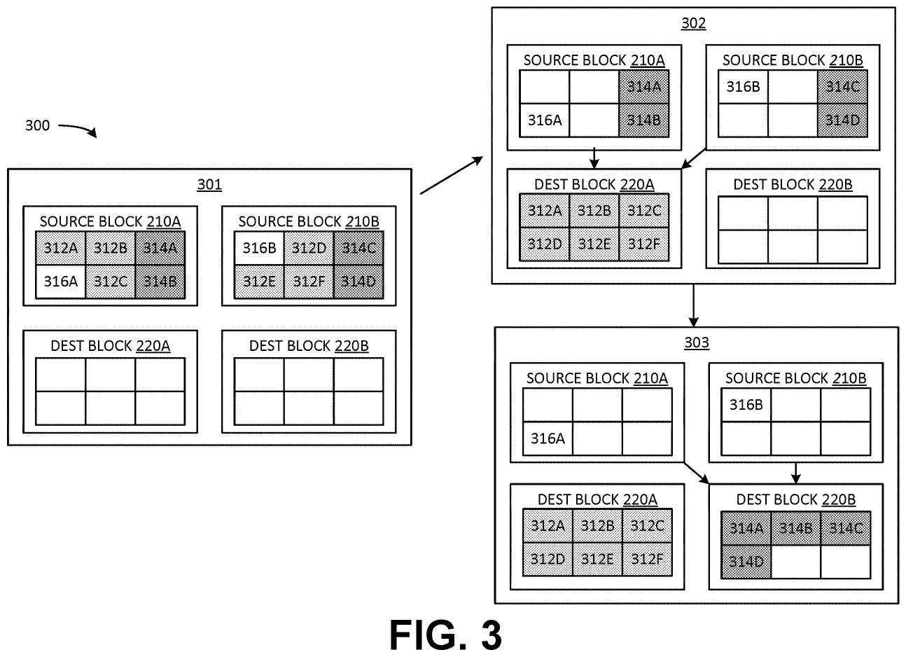

FIG. 3 is a block diagram illustrating the reordering process during garbage collection, in accordance with embodiments of the present disclosure. Source blocks 210 both include a first type of valid data 312A-F (herein referred to as a first type of data 312), a second type of valid data 314A-E (herein referred to as a second type of data 314), and invalid data 316A-B (herein referred to as invalid data 316). FIG. 3 is an illustrative example of one embodiment of the present disclosure. The amount of data types, source blocks, and destination blocks can vary depending on the embodiment.

At operation 301, the source blocks 210 and destination blocks 220 are identified by the garbage collection component 113. The garbage collection component 113 also identifies the valid data (e.g., first type of data 312 and second type of data 314) within each source block 210. In some embodiments, valid data can be identified using a logical to physical mapping table, which maps logical addresses corresponding to data to physical locations in the memory sub-system 110, to determine if there is a logical address associated with the data in the block. If there is not a logical address corresponding to the data, then the garbage collection component 113 can determine that the data is invalid. In other embodiments, data can include an indicator (e.g., a flag) to indicate whether the data is in use. If the indicator is set to a value indicating that the data is not in use, the garbage collection component 113 can determine that the data is invalid. In other or similar embodiments, the garbage collection component 113 can maintain a valid data table that tracks whether data in a block is valid or invalid. The garbage collection component 113 can reference the table during a garbage collection operation to identify the valid data.

At operation 302, garbage collection component 113 transfers the first type of data 312 to destination block 220A. Depending on the embodiment, types of data can include sequential and random data, user and non-user data, and/or data with a high write hotness and data with a low write hotness. Sequential data refers to data that is written and/or read in a continuous, ordered manner with adjacent logical addresses, while random data refers to data that is read and/or written out of order and scattered in non-contiguous locations. User data refers to data that is stored and/or accessed by a user and/or application (e.g., documents, application data, etc.), while non-user data refers to data stored by a system (e.g., system 100) and/or applications to manage and optimize storage and/or processing (e.g., metadata, system logs, error correction data, etc.). Data with a high write hotness refers to data that is frequently modified and/or overwritten in a short period of time, while data with a low write hotness refers to data that is not frequently modified and/or overwritten.

In some embodiments, the garbage collection component 113 can sort valid data into sequential and random data by identifying one or more logical addresses in a source block 210 that corresponds to valid data. The garbage collection component 113 can use the logical addresses to identify a chain of logical addresses that is sequential (e.g., 312A-B). The garbage collection component 113 can then determine the length of the chain of sequential logical addresses (e.g., by determining the number of logical addresses in the chain). If the length of the chain satisfies a threshold length criterion, then the garbage collection component 113 can determine that the data is sequential. For example, the garbage collection component 113 can determine whether the length of the chain meets a threshold length, in some embodiments. If the length meets or exceeds the threshold length, the data is determined to be sequential. If the length is below the threshold length, the data is determined to be random.

In other embodiments, the garbage collection component 113 can sort valid data based on whether the data is user or non-user data by identifying a logical address corresponding to valid data in source blocks 210 and determining whether the valid data is user data or non-user data based on a partition type associated with the logical address. For example, the logical block address can be partitioned (e.g., divided into smaller portions) to indicate what type of data is stored at each address. For example, logical addresses 0 to 100 can be allocated for storing media files and logical addresses 100-200 can be allocated for storing metadata. The garbage collection component 113 can determine the logical address associated with valid data and determine whether the data is user data or non-user data based on which partition the logical address is located in (e.g., data corresponding to a logical address of 50 will be determined to be user data because it is located in the partition allocated to media files). In some embodiments, the garbage collection component 113 can maintain a table indicating which logical addresses correspond to which type of data, which the garbage collection component 113 can use to determine the data type of valid data.

In other or similar embodiments, garbage collection component 113 can sort valid data based on write hotness by identifying a logical address corresponding to valid data and determining an over-write rate (e.g., the amount of times data is modified and/or overwritten in a period of time) of the valid data. In some embodiments, the over-write rate can be calculated by determining the amount of times a logical address receives a new write and calculating the average frequency of writes between the initial write time and the most recent write time. In other or similar embodiments, the over-write rate can be calculated based on the amount of times data is written over a specified time interval (e.g., 1 hour). In some embodiments, the garbage collection component 113 can maintain a log indicating the write frequency and/or amount of times data at each logical address has been written, which the garbage collection component 113 can use to determine the over-write rate of data at a logical address. The type of data can be determined based on whether the over-write rate satisfies a threshold criterion. For example, data with an over-write rate at or above the threshold value can be determined to have a high write hotness. Data with an over-write rate below the threshold value can be determined to have a low write hotness.

In some embodiments, garbage collection component 113 can determine which sorting algorithm to use based on one or more sorting criteria. For example, if the valid data is determined to include a large amount of sequential data (e.g., an amount of sequential data that meets or exceeds a threshold amount), the garbage collection component 113 can determine to sort based on sequential and random data. In other embodiments, if the garbage collection component 113 determines that valid data is associated with logical addresses that are partitioned, the garbage collection component can sort the data based on where the logical addresses are located. In other or similar embodiments, if the garbage collection component 113 determines that the other criteria are not satisfied for a sequential and/or partition-based sorting, the garbage collection component 113 can determine to sort based on write hotness.

After identifying the first type of data 312, garbage collection component 113 transmits (e.g., writes) the first type of data 312 to destination block 220A. In some embodiments, garbage collection component 113 determines whether the capacity of destination block 220A satisfies a capacity threshold prior to transmitting the second type of data 314 to destination block 220B. For example, garbage collection component 113 can determine whether destination block 220A has been completely filled. If the destination block 220A has been completely filled, then the garbage collection component 113 can proceed to operation 303. If the destination block 220A is not completely filled, then garbage collection component 113 can identify an additional source data block other than source blocks 210 and transfer valid data of the first type from the additional source data block until the destination block 220A is filled, in some embodiments. In other embodiments, the threshold capacity may be a portion of the total capacity of the destination block.

At operation 303, garbage collection component 113 transmits the second type of data 314 to destination block 220B. As such, destination data block 220A can be filled with only data of one data type (e.g., first type of data 312) while destination data block 220B is filled with data of only the second data type (e.g., second type of data 314). In some embodiments, identifying the valid data and transferring valid data of each type to the respective destination block 220 can be performed multiple pages at a time. For example, the garbage collection component 113 can identify valid data from the first five pages of source blocks 210 and transfer the valid data of each type from the first five pages of each source block 210 to the respective destination block 220. After completing the first five pages, the garbage collection component 113 can repeat the process with the next five pages of source blocks 210 until all the valid data is transmitted from each source block 210. Upon transferring the valid data to the destination blocks 220, the garbage collection component can release the source blocks 210 to erase the remaining invalid data 216.

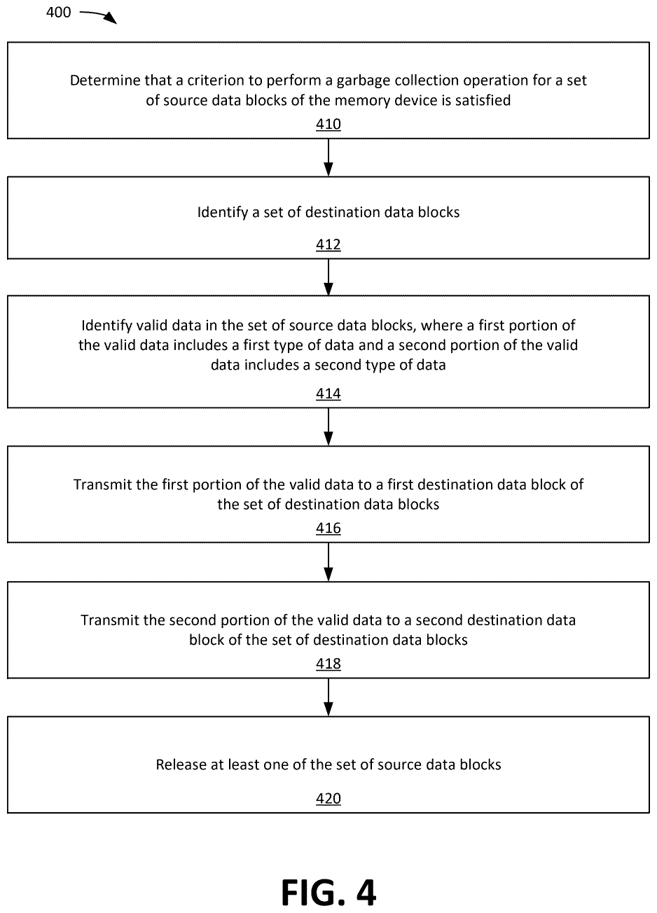

FIG. 4 is a flow diagram of an example method 400 to reorder data during garbage collection to mitigate write amplification in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the garbage collection component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic determines that a criterion to perform a garbage collection operation for a set of source data blocks of the memory device is satisfied. In some embodiments, the criterion can include a data capacity of the memory sub-system satisfying a memory threshold. For example, if the data capacity of the memory sub-system meets or exceeds a threshold value (e.g., 75% of the total capacity), the garbage collection component 113 can determine that the criterion is satisfied. In other embodiments, the criterion can include receiving a command (e.g., from the host system 120) to perform a garbage collection operation. In other or similar embodiments, a criterion can include the passage of a specified time interval after the last garbage collection operation. For example, if garbage collection is performed periodically every 5 minutes, then garbage collection component 113 can determine that the criterion is satisfied 5 minutes after the most recent garbage collection operation is performed. In some embodiments, the garbage collection component 113 can monitor performance metrics, such as processor utilization and/or input/output (I/O) queues for pending requests and comparing the metrics against predefined thresholds. For example, if the processor utilization meets or exceeds a threshold value, the garbage collection component 113 can determine that the criterion to perform garbage collection is satisfied. In other embodiments, if the I/O queue length meets or exceeds a threshold value, then the garbage collection component 113 can determine that a criterion is satisfied. After determining that the criterion is satisfied, the processing logic can identify the set of source data blocks, as described in FIG. 2, and proceed to operation 412.

At operation 412, the processing logic identifies a set of destination data blocks. In some embodiments, destination data blocks can be identified from one or more free blocks that are available to receive new data. The free blocks can be empty and/or contain data, depending on the embodiment. In some embodiments, the garbage collection component 113 can identify the destination data blocks based on factors such as the type of data already in the block, the amount of times the block has been erased, and/or internal transfer overhead caused by using the block, as described in FIG. 2.

At operation 414 the processing logic identifies valid data in the set of source data blocks, where a first portion of the valid data includes a first type of data and a second portion of the valid data includes a second type of data. Depending on the embodiment, valid data can be identified based on a physical mapping table to determine if there is a logical address corresponding to the data, flags corresponding to data that indicate whether data is in use, and/or a valid data table that indicates whether data is valid, as described in FIG. 3.

In some embodiments, data types can include sequential and random data, user and non-user data, and/or data with a high write hotness and data with a low write hotness. Sequential data, user data, and data with a low write hotness are likely to be valid for a longer period of time because the data is less likely to be updated over time. Random data, non-user data, and data with a high write hotness are likely to become invalid sooner because the data is more likely to be updated. As such, sorting data based on such characteristics can fill destination data blocks with data that will remain valid for similar periods of time. Depending on the embodiment, identification and sorting of valid data can be performed on portions (e.g., multiple pages) of each source block at one time, as described in FIG. 3.

At operation 416, the processing logic transmits the first portion of the valid data to a first destination data block of the set of destination data blocks. Depending on the embodiments, the first type of data can be identified based on the length of a chain of logical addresses, an associated partition characteristic, and/or an overwrite rate, as described in FIG. 3. In some embodiments, the garbage collection component 113 determines that a capacity of the first destination block satisfies a threshold criterion (e.g., the block has been filled to 75% of the storage capacity) before proceeding to operation 418, as described in FIG. 3. If the criterion is not satisfied, an additional source block may be used to fill the first destination block to satisfy the criterion, in some embodiments.

At operation 418, the processing logic transmits the second portion of the valid data to a second destination data block of the set of destination data blocks. In some embodiments, the first destination block can be filled with only the first type of data and the second destination block can be filled with only the second type of data.

At operation 420, the processing logic releases at least one of the set of source data blocks. Releasing a source data block includes erasing the invalid data and/or updating a characteristic of the data block (e.g., a flag or marker in metadata corresponding to the block) to indicate that the block is available for new data, in some embodiments. In other embodiments, the garbage collection component 113 can update a characteristic of the data block (e.g., a flag or marker) to indicate that the data in the block can be erased. In some embodiments, garbage collection component 113 can determine whether to release a source data block based on whether all the valid data from the source data block was transmitted to a destination block. For example, if an additional source block is used to fill a first destination block to satisfy a capacity threshold, as described in FIG. 3, the additional source block will not be released if there is valid data in the additional source block that was not transmitted to a destination block by the end of the garbage collection operation.

In some embodiments, after a destination block is filled to satisfy a capacity threshold, the garbage collection component 113 can determine whether there is valid data remaining in any source blocks used during the garbage collection operation. If any source blocks contain valid data, the garbage collection component 113 can open an additional destination block to use in place of the filled destination block (e.g., to store valid data of the same data type stored by the filled destination block) and continue the garbage collection operation. The process of opening additional destination blocks to collect valid data from source blocks can be repeated until the number of source blocks to be released exceeds the number of destination blocks used in the garbage collection operation (e.g., the number of destination blocks that received valid data), in some embodiments. Using the example above, the garbage collection component 113 can determine that the additional source block contains valid data after filling the first destination block to the capacity threshold and open an additional destination block, which stores the remaining valid data from the additional source block that is of the same data type stored by the first destination block. The garbage collection component 113 can continue the garbage collection operation using the additional destination block until all the valid data in the additional source block is transmitted to a destination block. If the number of source blocks to be released exceeds the number of destination blocks used, the garbage collection component 113 can release the source blocks and terminate the garbage collection operation. Otherwise, the garbage collection component 113 can continue to add additional source blocks and destination blocks in the garbage collection operation until the number of source blocks to be released exceeds the number of destination blocks used.

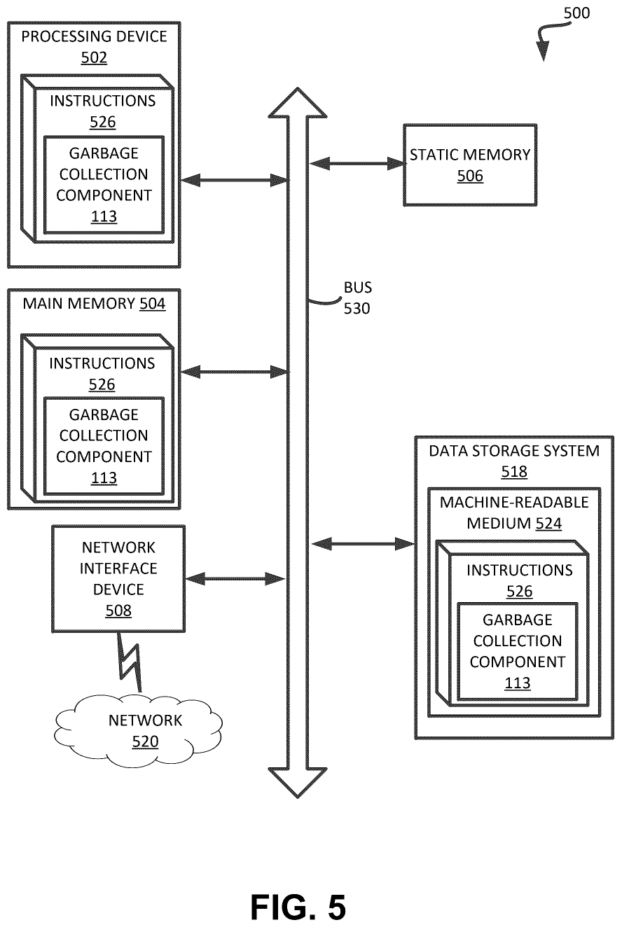

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the garbage collection component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a garbage collection component (e.g., the garbage collection component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising:
determining that a criterion to perform a garbage collection operation for a plurality of source data blocks of the memory device is satisfied;
identifying a plurality of destination data blocks;
identifying valid data in the plurality of source data blocks, wherein a first portion of the valid data comprises a first type of data and a second portion of the valid data comprises a second type of data;
classifying the valid data into the first type of data and the second type of data based on one or more sorting criteria determined from characteristics of the valid data;
transmitting the first portion of the valid data to a first destination data block of the plurality of destination data blocks;
transmitting the second portion of the valid data to a second destination data block of the plurality of destination data blocks; and
releasing at least one of the plurality of source data blocks.

2. The system of claim 1, wherein releasing at least one of the plurality of source data blocks comprises at least one of:
deleting invalid data in at least one of the plurality of source data blocks, or
marking at least one of the plurality of source data blocks for deletion of invalid data.

3. The system of claim 1, wherein a capacity of the first destination data block satisfies a capacity threshold prior to transmitting the second type of data to the second destination data block of the plurality of destination data blocks.

4. The system of claim 1, wherein the first destination data block consists of the first type of data and second destination data block consists of the second type of data.

5. The system of claim 1, wherein the processing device is to perform operations further comprising:
identifying one or more logical addresses corresponding to the valid data in the plurality of source data blocks;
determining a chain of the one or more logical addresses that are sequential;
determining a length of the chain of sequential logical addresses;
determining whether the length of the chain satisfies a threshold length criterion; and
upon determining the length satisfies the threshold length criterion, determining that the valid data corresponding to the one or more logical addresses in the chain is the first type of data.

6. The system of claim 1, wherein the processing device is to perform operations further comprising:
identifying a logical address corresponding to the valid data in the plurality of source data blocks; and
determining whether the valid data in the plurality of source data blocks is the first type of data based on a partition type associated with the logical address.

7. The system of claim 1, wherein the processing device is to perform operations further comprising:
identifying a logical address corresponding to the valid data in the plurality of source data blocks;
determining an over-write rate of the logical address; and
upon determining that the over-write rate satisfies an over-write threshold criterion, determining that the valid data corresponding to the logical address is the first type of data.

8. The system of claim 1, wherein transmitting the first type of data to the first destination data block of the plurality of destination data blocks comprises:
identifying a set of the first type of data in multiple pages of the plurality of source data blocks; and
transmitting the set of the first type of data to the first destination data block.

9. The system of claim 1, wherein releasing the at least one of the plurality of source data blocks comprises:
releasing a first number of the plurality of source data blocks, wherein the first number exceeds a second number of the plurality of destination blocks that received the valid data.

10. A method comprising:
determining that a criterion to perform a garbage collection operation for a plurality of source data blocks of a memory device is satisfied;
identifying a plurality of destination data blocks;
identifying valid data in the plurality of source data blocks, wherein a first portion of the valid data comprises a first type of data and a second portion of the valid data comprises a second type of data;
classifying the valid data into the first type of data and the second type of data based on one or more sorting criteria determined from characteristics of the valid data;
transmitting the first portion of the valid data to a first destination data block of the plurality of destination data blocks;
transmitting the second portion of the valid data to a second destination data block of the plurality of destination data blocks; and
releasing at least one of the plurality of source data blocks.

11. The method of claim 10, wherein releasing at least one of the plurality of source data blocks comprises at least one of:
deleting invalid data in at least one of the plurality of source data blocks, or
marking at least one of the plurality of source data blocks for deletion of invalid data.

12. The method of claim 10, wherein a capacity of the first destination data block satisfies a capacity threshold prior to transmitting the second type of data to the second destination data block of the plurality of destination data blocks.

13. The method of claim 10, wherein the first destination data block consists of the first type of data and the second destination data block consists of the second type of data.

14. The method of claim 10, further comprising:
identifying one or more logical addresses corresponding to the valid data in the plurality of source data blocks;
determining a chain of the one or more logical addresses that are sequential;
determining a length of the chain of sequential logical addresses;
determining whether the length of the chain satisfies a threshold length criterion; and
upon determining the length satisfies the threshold length criterion, determining that the valid data corresponding to the one or more logical addresses in the chain is the first type of data.

15. The method of claim 10, further comprising:
identifying a logical address corresponding to the valid data in the plurality of source data blocks; and
determining whether the valid data in the plurality of source data blocks is the first type of data based on a partition type associated with the logical address.

16. The method of claim 10, further comprising:
identifying a logical address corresponding to the valid data in the plurality of source data blocks;
determining an over-write rate of the logical address; and
upon determining that the over-write rate satisfies an over-write threshold criterion, determining that the valid data corresponding to the logical address is the first type of data.

17. The method of claim 10, wherein transmitting the first type of data to the first destination data block of the plurality of destination data blocks comprises:
identifying a set of the first type of data in multiple pages of the plurality of source data blocks; and
transmitting the set of the first type of data to the first destination data block.

18. A non-transitory computer-readable storage medium comprising instructions that, when executed by a processing device, cause the processing device to perform operations comprising:
determining that a criterion to perform a garbage collection operation for a plurality of source data blocks of a memory device is satisfied;
identifying a plurality of destination data blocks;
identifying valid data in the plurality of source data blocks, wherein a first portion of the valid data comprises a first type of data and a second portion of the valid data comprises a second type of data;
classifying the valid data into the first type of data and the second type of data based on one or more sorting criteria determined from characteristics of the valid data;
transmitting the first portion of the valid data to a first destination data block of the plurality of destination data blocks;
transmitting the second portion of the valid data to a second destination data block of the plurality of destination data blocks; and
releasing at least one of the plurality of source data blocks.

19. The non-transitory computer-readable storage medium of claim 18, wherein releasing at least one of the plurality of source data blocks comprises at least one of:
deleting invalid data in at least one of the plurality of source data blocks, or
marking at least one of the plurality of source data blocks for deletion of invalid data.

20. The non-transitory computer-readable storage medium of claim 18, wherein a capacity of the first destination data block satisfies a capacity threshold prior to transmitting the second type of data to the second destination data block of the plurality of destination data blocks.
